(19) United States
(12) Patent Application Publication
(10) Pub. No.: US 2009/0083112 A1
(43) Pub. Date: Mar. 26, 2009

(54) Automated Event Modification in Electronic Calendar Systems

(75) Inventors: Kulvir Singh Bhogal, Fort Worth, TX (US); Robert Ross Peterson, Austin, TX (US); Lisa Anne Seacat, San Francisco, CA (US)

Correspondence Address: MOLLBORN PATENTS, INC., 2840 COLBY DRIVE, BOULDER, CO, 80305, US

(73) Assignee: International Business Machines Corporation, Armonk, NY (US)

(21) Appl. No.: 11/859,927

(22) Filed: Sep. 24, 2007

(51) Int. Cl. G06Q 10/00; G06F 17/00; G06F 17/40

(52) U.S. Cl. 705/9

(57) ABSTRACT

Methods and apparatus, including computer program products, implementing and using techniques for modifying an event in an electronic calendar system. An event invitation is created in the electronic calendar system. A first timeout value is associated with the event invitation. The first timeout value specifies a time for replying to the event invitation. The event invitation is sent to one or more invitees and the first timeout value is applied to at least a subset of the one or more invitees. If a response to the event invitation is not received from an invitee with an applied timeout value within the time specified by the first timeout value, a first action relating to the event is performed.

### BACKGROUND

This invention relates to electronic calendar systems. Electronic calendar systems have become an increasingly common work support tool, both within organizations and for private users. Typically, electronic calendar systems contain functionality for automatically checking electronic calendars of other users, such as members in a work team, for open time slots, proposing alternative meeting times, scheduling team meetings or appointments, and notifying and reminding invitees by email about their upcoming meetings.

Generally, when a user schedules a meeting through an electronic calendar system the scheduled time slot for the meeting becomes unavailable in their calendar for other meeting requests and events. In most cases, this is what the user wants to happen. However, there are also cases where tentative meeting invitees who have received meeting invitations do not respond to their invitations, and as a result the meeting will not occur. In these situations, the tentative meeting invitees may want to free up the time slot that was originally blocked off for the meeting for other kinds of activities.

In conventional electronic calendar systems, users other than the meeting organizer must cancel their calendar entries through a manual process. Each user who has accepted an invitation for a meeting that will not occur must locate the meeting time slot in their calendar, and manually delete the calendar entry. This process can be both time consuming and frustrating. When the meeting organizer cancels a meeting, a cancellation notification is typically sent out to the invitees, who can cancel the event by accepting the cancellation notification. That is, the process is somewhat more automated. However, it is clear that there is a need for an improved electronic calendar system that is more user-friendly.

### SUMMARY

In general, in one aspect, the invention provides methods and apparatus, including computer program products, implementing and using techniques for modifying an event in an electronic calendar system. An event invitation is created in the electronic calendar system. A first timeout value is associated with the event invitation. The first timeout value specifies a time for replying to the event invitation. The event invitation is sent to one or more invitees and the first timeout value is applied to at least a subset of the one or more invitees. If a response to the event invitation is not received from an invitee with an applied timeout value within the time specified by the first timeout value, a first action relating to the event is performed

The various embodiments of the invention can include one or more of the following advantages. Events that have been posted to an electronic calendar can be automatically canceled, as simple as adding events, without users having to locate and delete the calendar event manually. The automatic cancellation can be made contingent on the responses (or lack thereof) to meeting invitations by certain individuals or by groups of individuals, and/or the availability of meeting resources, such as rooms or various types of equipment needed for the meeting. Different time periods during which particular invitees or groups of invitees must respond to a meeting invitation can be defined.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a schematic view of a meeting creation window in an electronic calendar in accordance with one embodiment of the invention.

FIG. 2 shows a process for scheduling a meeting with an automatic cancellation feature in accordance with one embodiment of the invention.

Like reference symbols in the various drawings indicate like elements.

### DETAILED DESCRIPTION

The various embodiments of the invention described herein pertain to enhancements of electronic calendar systems. In particular, a person scheduling an event, such as a meeting, can specify a timeout interval for the invitees of the event. If the invitees who are required to attend the event do not respond within the specified timeout interval, or initially accept the event invitation and subsequently decide to cancel, the event is automatically cancelled. Various embodiments of the invention will now be described by way of example of a meeting event, and with reference to the drawings. It should however be realized that the principles described below can be applied to any type of event that can be represented by an entry in an electronic calendar system.

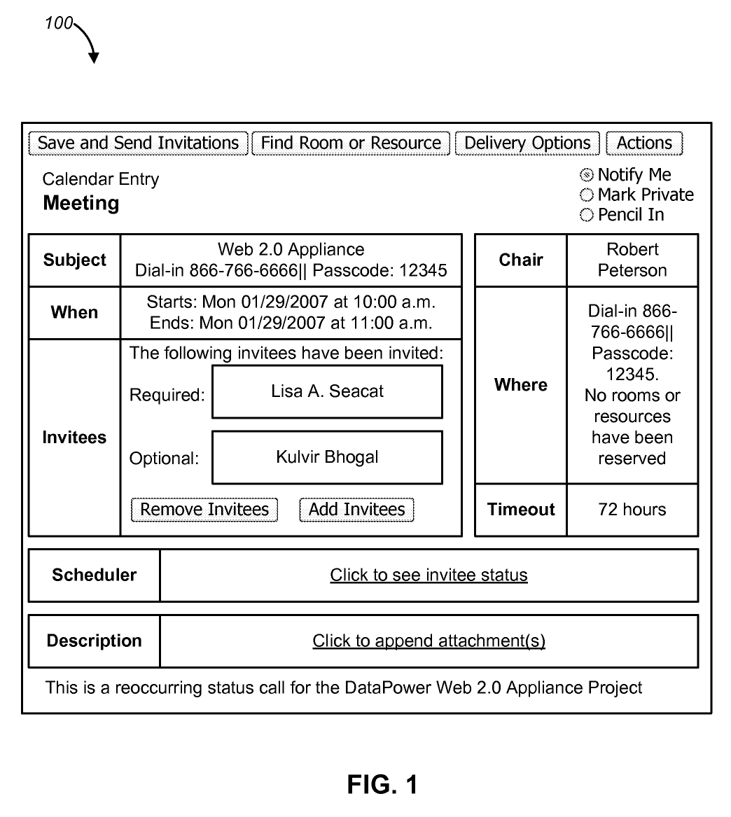

FIG. 1 shows a schematic view of a user interface representing a meeting creation window (100) in an electronic calendar application. The meeting creation window (100) allows a user, herein referred to as a scheduler, to enter information pertaining to an invitation that is to be sent out to a group of people, herein referred to as invitees, about a meeting. As can be seen in FIG. 1, the meeting creation window (100) allows the scheduler to enter information about, for example, the subject of the meeting, when the meeting is scheduled, where the meeting will be held, a time for the meeting, the chair of the meeting, and the invitees of the meeting, similar to conventional electronic calendars.

In the embodiment shown in FIG. 1, the invitees are divided into required invitees and optional invitees. Typically, a required invitee is an individual whose attendance is necessary for the meeting to occur, and an optional invitee is an individual whose attendance is desired but not necessary for the meeting to occur. It should be noted that in other implementations, other categories can be defined in addition to or to replace the “required” and ”optional” categories. For example, there may be a “substitute” category of invitees that can receive an invitation to replace an invitee who declines the meeting.

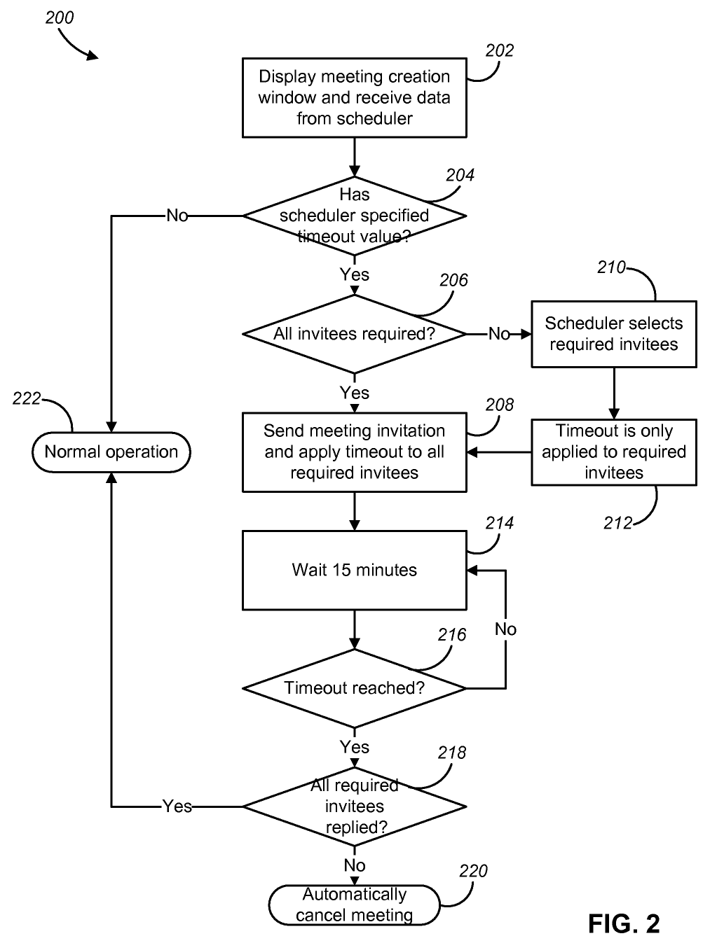

As can be seen in FIG. 1, there is also a timeout value associated with the meeting invitation. In the case illustrated in FIG. 1, the scheduler has specified the timeout value of 72 hours. The timeout value specifies a time period during which the invitees must respond to the invitation. If no response is received within this time period, the meeting will be automatically canceled and removed from the invitees' and the scheduler's calendars, as will be described below in further detail and with reference to FIG. 2. This obviates the need for the invitees and scheduler to manually delete the calendar entry for the meeting from their calendars. It should be noted that in various embodiments, actions other than automatic canceling can occur. For example, if an invitee has not responded within the preset time period, a reminder can be sent to the invitee, for example, in case she lost the first invitation. The note may optionally also be sent to an administrative assistant of the invitee. If no response has still been received after a second time period associated with the reminder, then the meeting can be automatically canceled. Thus, the automatic cancellation described below is merely one example of a whole range of possible actions that may be taken when the timeout value expires.

In various embodiments of the invention, the scheduler can also perform additional functions in the meeting creation window (100). Some examples are IS illustrated in FIG. 1, such as clicking a link to view invitee status, that is, who has responded to the invitation after the invitation was sent out. The scheduler can also, optionally, attach documents, images, or other electronic computer files to the invitation, add notes at the end of the meeting invitation, and see how much time remains for the invitees to respond to the invitation. Many similar variations and options can be realized by those of ordinary skill in the art.

FIG. 2 shows a process (200) for scheduling a meeting with an automatic cancellation feature in accordance with one embodiment of the invention. As can be seen in FIG. 2, the process starts by displaying a meeting creation window (100) as shown in FIG. 1 to the scheduler (step 202), in which the scheduler enters data as described above. The process then checks whether the scheduler has specified a timeout value (step 204). If the scheduler has not specified a timeout value, the process continues to step 222 where normal operation proceeds, that is, the meeting is added to the invitees' calendars and the invitees typically attend the meeting, similar to conventional electronic calendar systems.

If the scheduler has specified a timeout value in step 204, the process continues by checking whether all invitees are required, or whether there are some required and some optional invitees (step 206). If all invitees are required invitees, the process continues to step 208 where the meeting invitation is sent out to all the required invitees. If the scheduler has specified that there are both required and optional invitees in step 206, the scheduler selects the required invitees (step 210). The process then applies the timeout to the required invitees (step 212), and the meeting invitation is sent out (step 208).

After the meeting invitation has been sent out to the invitees, the process waits for 15 minutes (step 214), or any other suitable length of time depending on the timeout value specified by the scheduler, and then the process checks whether the timeout value has been reached (step 216). If the timeout value has not been reached, the process returns to step 214 and waits another 15 minutes. When the process determines in step 216 that the timeout value has been reached, the process checks whether all the required invitees have replied (step 218). If all the invitees have replied within the specified timeframe, the process continues to step 222 and proceeds with normal operation, similar to conventional electronic calendar systems. If one or more of the required invitees has not replied to the invitation in step 218, then the process cancels the meeting and automatically deletes the meeting entries from the scheduler's and invitees' electronic calendars (step 220) so that the timeslot can be used for other purposes. This ends the process (200).

In some embodiments, before the automated cancellation in step 220, the process can optionally notify the required invitees with an automated email, chat message, SMS, or the like that they have one last chance to accept the meeting before the meeting is cancelled. Typically a second, shorter, time period value is associated with this notification, and if no response is received within this second time period, the meeting is canceled.

In some embodiments, a resource associated with the meeting, such as a meeting room or some type of equipment that has been reserved for the meeting can be freed up based on the automated meeting cancellation in step 220. Thus, the electronic calendar system can communicate with a room reservation or equipment reservation system to automatically free up the meeting room or resource associated with the meeting. The room reservation or equipment reservation system can either be part of the electronic calendar system or be an external system with which the electronic calendar system can communicate.

Furthermore, in some embodiments the meeting scheduler can assign different timeout intervals to different meeting invitees. This allows the scheduler to give extra time to reply to some individuals, which may be useful, for example, when an invitee is traveling and may not have regular access to his electronic calendar. Alternatively, the timeout intervals can be assigned based on seniority or position within a company. For example, a CEO can be given 72 hours to respond to an invitation, whereas a patent engineer can be given 6 hours to respond to the same invitation.

In some embodiments, instead of completely cancelling the meeting as described above for step 220, which typically requires that the scheduler prepares a new meeting invitation from scratch, the time slots in the invitees' calendars and the rooms and optionally other resources (e.g., projector, catering, etc.) are freed up, and the meeting invitation is returned to the scheduler for revision. This allows the scheduler to make much fewer changes than would typically be involved in creating a completely new meeting invitation from scratch, and then to resend the meeting invitation to the invitees.

In some embodiments, the status of the meeting can be indicated to the invitees. In general, meetings can have two or three status values, such as “proposed,” “confirmed,” “cancelled” and so on. Invitees may want to be able to differentiate between additional states, such as “proposed—pending critical resources” versus “proposed—critical resources committed∞ and so on. An invitee facing a scheduling conflict may want to revisit a meeting proposal to determine whether the “critical resources” have been committed.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

A number of implementations of the invention have been described. Nevertheless, it will be understood that various modifications may be made without departing from the spirit and scope of the invention. Accordingly, other embodiments are within the scope of the following claims.

1. A computer-implemented method for modifying an event entry in an electronic calendar system, the method comprising:
creating an event invitation in the electronic calendar system;
associating a first timeout value with the event invitation, the first timeout value specifying a time for replying to the event invitation;
sending the event invitation to one or more invitees and applying the first timeout value to at least a subset of the one or more invitees; and
in response to not receiving a response to the event invitation from an invitee with an applied timeout value within the time specified by the first timeout value, performing a first action relating to the event.

2. The method of claim 1, wherein the first action relating to the event is one of: sending a reminder to each invitee who has not responded to the invitation, canceling the event from the electronic calendar system, and returning the event invitation to a scheduler of the event for revision.

3. The method of claim 1, wherein the one or more invitees include required invitees and optional invitees, and applying the timeout value to at least a subset of the one or more invitees includes applying the first timeout value to the required invitees.

4. The method of claim 3, further comprising:
in response to a required invitee declining the event invitation, canceling the event from the electronic calendar system

5. The method of claim 1, further comprising:
displaying a status for each invitee that has received an event invitation, the status specifying one of: the invitee has accepted the event invitation, the invitee has declined the event invitation, the invitee has not responded to the event invitation, how long it took for the invitee to respond to the event invitation, and how much time the invitee has left to respond to the event invitation before the timeout value is reached.

6. The method of claim 1, further comprising:
associating a second timeout value with the reminder; and
canceling the event from the electronic calendar system when no response is received from the invitee before the expiration of the second timeout.

7. The method of claim 1, further comprising:
reserving at least one resource to be used during the event; and
wherein the first action includes canceling the reservation of the at least one resource.

8. The method of claim 1, further comprising:
applying different timeout values to different subsets of invitees

9. The method of claim 1, further comprising:
displaying a meeting status to one or more of the invitees.

10. The method of claim 6, further comprising:
displaying a resource status to one or more of the invitees.

11. A computer program product comprising a computer useable medium including a computer readable program, wherein the computer readable program when executed on a computer causes the computer to:
create an event invitation in an electronic calendar system;
associate a first timeout value with the event invitation, the first timeout value specifying a time for replying to the event invitation;
send the event invitation to one or more invitees and applying the first timeout value to at least a subset of the one or more invitees; and
in response to not receiving a response to the event invitation from an invitee with an applied timeout value within the time specified by the first timeout value, perform a first action relating to the event.

12. The computer program product of claim 11, wherein the first action relating to the event is one of: sending a reminder to each invitee who has not responded to the invitation, canceling the event from the electronic calendar system, and returning the event invitation to a scheduler of the event for revision.

13. The computer program product of claim 11, wherein the one or more invitees include required invitees and optional invitees, and applying the timeout value to at least a subset of the one or more invitees includes applying the first timeout value to the required invitees.

14. The computer program product of claim 13, further causing the computer to:
in response to a required invitee declining the event invitation, cancel the event from the electronic calendar system

15. The computer program product of claim 11, further causing the computer to:
display a status for each invitee that has received an event invitation, the status specifying one of: the invitee has accepted the event invitation, the invitee has declined the event invitation, the invitee has not responded to the event invitation, how long it took for the invitee to respond to the event invitation, and how much time the invitee has left to respond to the event invitation before the timeout value is reached.

16. The computer program product of claim 11, further causing the computer to:
associate a second timeout value with the reminder; and
cancel the event from the electronic calendar system when no response is received from the invitee before the expiration of the second timeout.

17. The computer program product of claim 11, further causing the computer to:
reserve at least one resource to be used during the event; and
wherein the first action includes canceling the reservation of the at least one resource.

18. The computer program product of claim 11, further causing the computer to:
apply different timeout values to different subsets of invitees

19. The computer program product of claim 11, further causing the computer to:
display a meeting status to one or more of the invitees.

20. The computer program product of claim 16, further causing the computer to:
display a resource status to one or more of the invitees.

21. An electronic calendar system comprising:
means for creating an event invitation in the electronic calendar system;
means for associating a first timeout value with the event invitation, the first timeout value specifying a time for replying to the event invitation;
means for sending the event invitation to one or more invitees and applying the first timeout value to at least a subset of the one or more invitees; and
in response to not receiving a response to the event invitation from an invitee with an applied timeout value within the time specified by the first timeout value, means for performing a first action relating to the event.

22. The electronic calendar system of claim 21, wherein the first action relating to the event is one of: sending a reminder to each invitee who has not responded to the invitation, canceling the event from the electronic calendar system, and returning the event invitation to a scheduler of the event for revision.

23. The electronic calendar system of claim 1, wherein the one or more invitees include required invitees and optional invitees, and applying the timeout value to at least a subset of the one or more invitees includes applying the first timeout value to the required invitees.

24. The electronic calendar system of claim 23, further comprising:
in response to a required invitee declining the event invitation, means for canceling the event from the electronic calendar system

25. The electronic calendar system of claim 21, further comprising:
means for reserving at least one resource to be used during the event; and
wherein the first action includes canceling the reservation of the at least one resource.
